(19) United States
(12) Patent Application Publication
(10) Pub. No.: US 2019/0027738 A1
(43) Pub. Date: Jan. 24, 2019

(54) MULTI-FUNCTIONAL ELECTRODE ADDITIVE

(71) Applicant: pH Matter, LLC, Columbus, OH (US)

(72) Inventors: Minette Ocampo, Columbus, OH (US); Paul H. Matter, Columbus, OH (US); Michael G. Beachy, Gahanna, OH (US); Chris T. Holt, Bexley, OH (US); Julia R. Mueller, Columbus, OH (US)

(21) Appl. No.: 16/037,377

(22) Filed: Jul. 17, 2018

Related U.S. Application Data
(60) Provisional application No. 62/533,733, filed on Jul. 18, 2017.

(51) Int. Cl. H01M 4/133; H01M 4/1393; H01M 4/88; H01G 11/38

(52) U.S. Cl. CPC H01M 4/133; H01M 4/1393; H01M 4/625; H01G 11/38; H01M 4/8807

(57) ABSTRACT

This invention discloses a multifunctional electrode additive and methods for forming electrodes that incorporate the additive. The additive may be an electro-active carbon, such as nitrogen and/or phosphorous doped carbon, with functional groups that form a hydrophobic surface. The additive has a combination of properties that make it useful in a number of electrode and other applications.

### CROSS-REFERENCE TO RELATED APPLICATIONS

This application claims the benefit of U.S. Provisional Patent Application 62/533,733; filed Jul. 18, 2017.

### STATEMENT REGARDING FEDERALLY SPONSORED RESEARCH OR DEVELOPMENT

This invention was made with government support under National Science Foundation Contract IIP-1330169, Department of Energy Contract DE-SC0013111, and Department of Energy Contract DE-SC0017144. The government may have certain rights in the invention.

### TECHNICAL FIELD

The present disclosure relates generally to the field of catalyst chemistry, and particularly to an electro-active carbon-based multi-functional electrode additive comprising hydrophobic functional groups chemically bonded to the surface

### BACKGROUND OF THE INVENTION

Carbon is used as a component in many electrode applications, such as fuel cells, batteries, electrolysis, and capacitors. Carbon has numerous advantageous properties for electrode applications, including high surface area and electrical conductivity. In the case of fuel cells, carbon particles are often used in electrode layers as either a catalyst or catalyst support. Carbon is also used in the micro-porous layer (MPL) of fuel cells to provide contact between the electrode catalyst and gas diffusion layer (GDL). The GDL is also often made of carbon. In redox flow batteries and metal-air batteries, electrodes may have configurations very similar to a fuel cell, and thus may use carbon particles in a similar manner.

In the case of lithium ion batteries (LIBs), carbon is often used as an additive in both the cathode and anode to improve electrical conductivity. In the anode of lithium ion batteries, carbon may further store lithium ions between atomic layers (intercalation) or it may protect lithium alloying materials, such as silicon, from corrosion. In the case of capacitors, high surface area carbon materials may be used in electrodes to store an electrical charge at the interface with an electrolyte.

Functionalization of carbon can improve the properties of carbon materials for use in many electrode applications, including the aforementioned applications discussed above. Functionalization can make carbon less inert or more “electro-active” for intended electrochemical uses. Functionalization of carbon may include doping the carbon with other atoms, including B, N, F, Si, P, S, or Cl, using techniques well-known to those skilled in the art. Functionalization may also include imparting surface functional groups on the carbon surface, again using techniques well-known to those skilled in the art. In the case of fuel cells, redox flow batteries and metal-air batteries, functionalization of carbon has been shown to make the carbon electro-active for chemical reactions.

For example, doping carbon with nitrogen and/or phosphorus can impart activity into carbon for the oxygen reduction reaction, a useful electrochemical reaction for a number of electrode applications, including fuel cells, metal air batteries, redox flow batteries, and oxygen depolarized cathode electrolysis. Nitrogen doping of carbon is useful for supercapacitors to improve electron donating properties of the carbon. Further, nitrogen doping can improve the lithium ion capacity of carbon, or can act as a basic group to neutralize corrosive compounds. A drawback of nitrogen functionalization of carbon is that the nitrogen functional groups can make carbon hydrophilic, which is not desirable for many applications.

Hydrophobicity is an important property for many electrodes. In gas diffusion electrodes (GDEs) used in applications including fuel cells, metal air batteries, electrolysis, and some types of redox flow batteries, hydrophobicity is used to prevent GDEs from flooding with water. Water flooding limits gases from being able to quickly diffuse to or from catalytic active sites in the electrode catalyst layer. In the case of lithium ion batteries and capacitors, cells often use non-aqueous electrolytes and operate at voltages higher than about 1.2 V. In these cases, water may react with the electrolyte and/or may react to form gases that lead to cell failure.

Consequently, in many cases, using hydrophobic carbon in the electrodes is advantageous to minimize water in the cell and/or lower processing costs. In the case of LIBs, hydrophobicity of the electrodes can extend battery life by limiting retained water, which can react with the electrolyte to form hydrofluoric acid that ultimately corrodes the active ceramic and metals used in the battery components.

Hydrophobicity of electrodes can be modified by a number of approaches that offer advantages and disadvantages. A simple route to increase electrode hydrophobicity is to add a hydrophobic polymer, such as poly-tetrafluoroethylene (PTFE), during electrode processing. The downside of polymer addition is that hydrophobic polymers are generally not electrically conductive, they are generally not electro-active, and can cover electro-active surfaces within the electrode. Carbon particles themselves can be made more hydrophobic through heat treatment or graphitization. A down-side of this approach is the cost associated with the high temperature heat treatment processing and a loss in electro-active sites on the carbon that can occur at higher temperatures.

Heat treatments increase graphiticity and particle size of carbon, thus decreasing surface functional groups, surface area, active sites, and dislocations. Methods have been developed to add hydrophobic functional groups to the surface of carbon particles for use as electrode additives. One approach involves plasma treatment of the carbon, which oxidizes the carbon surface and can destroy surface functional groups on the carbon. After oxidation, hydrophobic molecules are bonded to the surface. While this approach forms a conductive hydrophobic particle suitable for use in electrodes, the material would not have additional electro-active functionality. Carbon fiber paper may be treated within a CF₄ plasma atmosphere, by directly attaching CF₄ to the surface of the carbon, thereby giving it hydrophobic properties. This approach does not produce electro-active carbon, the treatment may destroy any other surface functional groups, and may be difficult to scale for larger quantities of powder processing. Covalent bonding of fluorocarbon functional groups to the surface of carbon paper has also been investigated. One approach uses diazonium salt solutions to electrochemically bond the functional groups onto the GDL surface. The surface treatment functionalizes the carbon and makes it more hydrophobic, although the resulting carbon would not be electro-active. This approach may also be difficult to scale for larger quantities of materials.

### SUMMARY OF THE INVENTION

The instant invention as disclosed in multiple embodiments, all meant by way of example only and not limitation, may include an additive that solves many of the limitations of the existing art. The design, in multiple embodiments, may include an electro-active carbon-based multi-functional electrode additive that has hydrophobic functional groups chemically bonded to the surface. In various embodiments, the additive includes electro-active surface functional groups with free electron pairs and/or hydrophobic functional groups that may include silicon bonded to the carbon surface. The additive can include a nitrogen content of 0.1-20%, while in some embodiments, the additive can include an oxygen content of 0.1-20%. The additive may have a phosphorous content of 1 ppm to 1%, and may have a silicon particle core.

In various functional applications, the additive may be a support for a catalyst, and may further include platinum. In some embodiments, the additive may be an electro-catalyst, and may include at least one region having a one hydrophilic functional group. In certain embodiments, a functional group includes C1 to C30 fluorocarbon, while a functional group may also self-assemble to form a single molecule coating. Additionally, a functional group may include C1 to C30 hydrocarbon.

In a series of other embodiments, the additive may variously have a surface area measuring greater than 100 m2/g, and/or a surface area measuring greater than 500 m2/g. From a functional viewpoint, the additive and catalyst can produce measurable current for oxygen reduction >1 mA/cm2 of a coated geometric area at >0.8 V versus a reversible hydrogen electrode. In other embodiments, the additive can produce measurable current for oxygen reduction >1 mA/cm2 of a coated geometric area at >0.6 V versus a reversible hydrogen electrode.

In yet other embodiments, the additive may be applied to a variety of devices, including by way of example only and not limitation, and as would be known to one skilled in the art, such devices as a gas diffusion electrode, a battery electrode, a gas diffusion layer, an electrolysis electrode and/or a supercapacitor electrode.

One skilled in the art would know multiple methods for building and utilizing the devices and procedures outlined in the present teaching. On method could include the steps of, first, preparing carbon doped with a compound consisting of boron, nitrogen, fluorine, phosphorous, sulfur and/or chlorine; and then exposing the doped carbon to a reactive silane having at least one hydrophobic functional group. Ultimately, the carbon could be incorporated into an electrode.

### BRIEF DESCRIPTION OF THE ILLUSTRATIONS

Without limiting the scope of the electrochemical cell as disclosed herein and referring now to the drawings and figures:

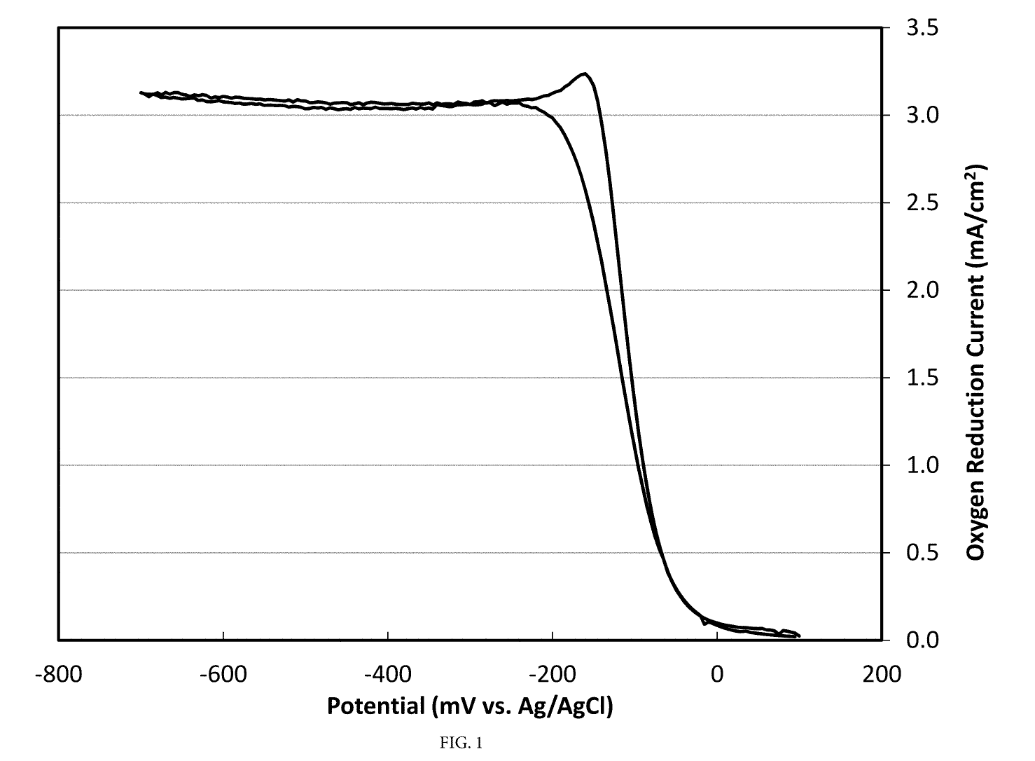

FIG. 1 shows oxygen reduction current density versus voltage, as measured by a cycling voltammetry method in oxygen-saturated 1 M KOH, demonstrating electro-activity of a multi-functional additive;

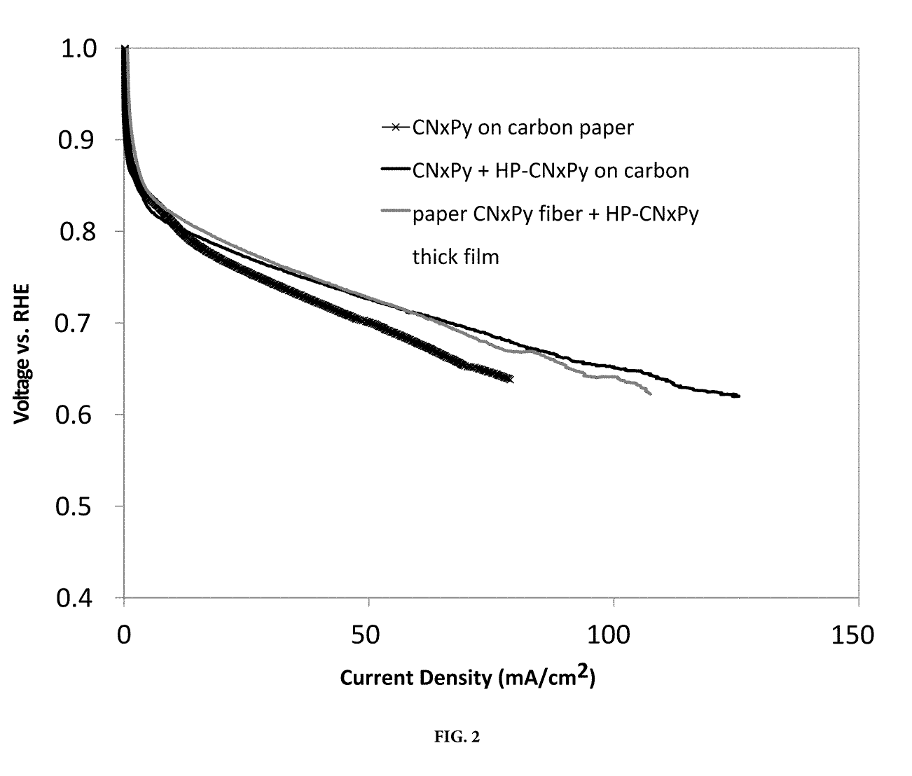

FIG. 2 shows oxygen reduction current density versus voltage, as measured in a GDE, demonstrating improved performance through incorporation of the multi-functional additive in an electrode; and

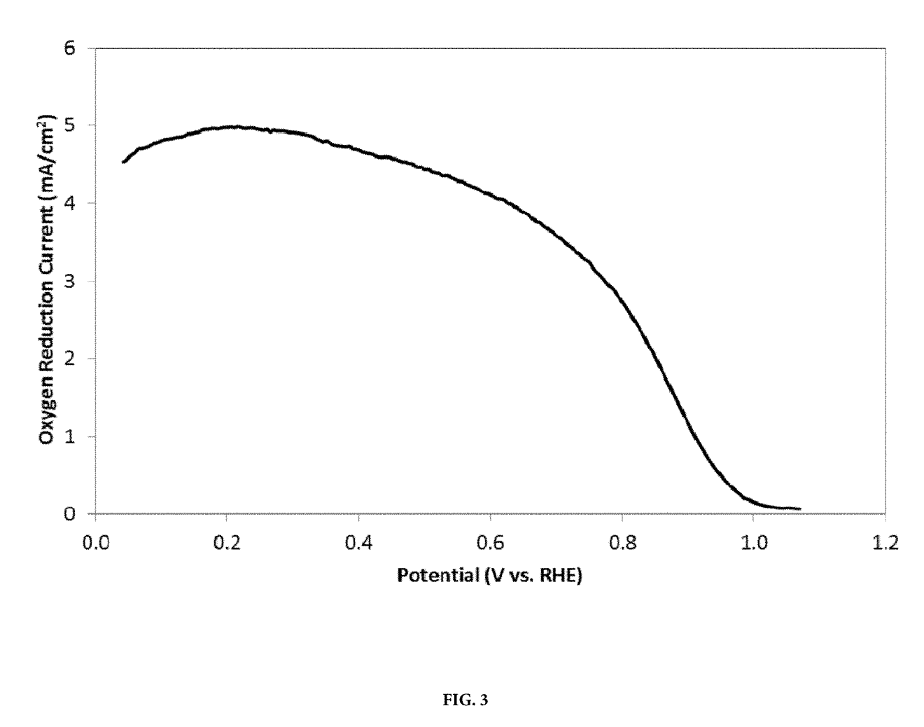

FIG. 3 shows oxygen reduction current density versus voltage, as measured by a cycling voltammetry method in oxygen-saturated 0.1 M perchloric acid, demonstrating electro-activity of a catalyst supported by a multi-functional additive.

These illustrations are provided to assist in the understanding of the exemplary embodiments of an electro-active carbon-based multi-functional electrode additive, and a method for using the same, as described in more detail below, and should not be construed as unduly limiting the specification. In particular, the relative spacing, positioning, sizing and dimensions of the various elements illustrated in the drawings may not be drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The instant invention reveals a multifunctional electrode additive that is both hydrophobic and electro-active, methods for making the additive, methods for forming electrodes using the additive, and uses for the additive. The additive can be a nitrogen and/or phosphorous doped carbon (CNₓP_{y}) material with oxygen surface groups. The surface of the particles is bound to hydrophobic functionalities to form a hydrophobic particle surface. The additive has a unique combination of properties that can make it useful in a number of electrode applications. The unique combination of properties can include, but are not limited to: regions of hydrophobicity, electrochemical activity for reactions including reduction of oxidants, electrical conductivity, high surface area, porosity optimized for the electrode application, strong bonding to metal catalysts through electron donation from atoms on the surface that contain free electron pairs, such as N or P, and electron donation to ions or molecules in the electrolyte.

### Example #1: Electro-Active Carbon Preparation

Electro-active CNₓP_{y} nanofibers were prepared using standard procedures known in the art. Briefly, 35 grams of cobalt nitrate hexahydrate and 105 grams of ferric nitrate nonahydrate were mixed in 200 g of distilled water on a stir plate until all solids dissolved. Half of the solution was then added dropwise to 280 g of MgO and stirred until heterogeneous and the MgO absorbed the solution. The mixture was then dried at 70° C. overnight.

The following day, the remaining solution was added to the dried precursor and stirred. The material was then dried again overnight at 70° C. The following day, 1 gram of Tri-Phenyl Phosphine (TPP) dissolved in ethanol was added to the solids dropwise, then dried for 2 hours at 70° C. Next, 200 g of the precursor was loaded into a reactor being fed with nitrogen saturated at room temperature with pre-vaporized acetonitrile and the reactants were heated to 1000° C. The precursor was then treated at 1000° C. for 30 minutes, with nitrogen/acetonitrile flowing at 5.0 slpm and a temperature of 1000° C.

The product was then washed with 2 L of 2 M hydrochloric acid heated to 70-80° C. The solution with the catalyst was stirred continuously on a stir plate at 70-80° C. for 1 hour. The resulting carbon was then filtered and washed with distilled water. The carbon was then dried at 70° C. overnight to form CNₓP_{y}. Surface analysis by X-Ray Photo-electron Spectroscopy (XPS) confirmed that the material contains 7.2% nitrogen, 0.1% phosphorous, and 4.7% oxygen. The oxygen species can at least partially be attributed to hydroxides based on the binding energy, which substantially ranged between 532 and 534 eV. The oxygen surface species may form upon exposure of the CNₓP_{y} to air after the pyrolysis synthesis and/or during the acid wash. Based on the binding energy of the nitrogen species, the carbon contains substantial pyridinic nitrogen (˜399 eV).

Those skilled in the art would appreciate that pyridinic nitrogen contains a free electron pair and is associated with electro-activity. The composition values fall within the range typically reported using similar methods for CNₓP_{y} preparation.

While the above description represents a preferred method for electro-active carbon preparation, those skilled in the art would appreciate numerous other methods to prepare electro-active carbon. These methods can involve pyrolysis at other temperatures between 200 and 3000° C., various pyrolysis treatment times, various pyrolysis conditions including other pressures and atmospheres, pyrolysis of other hydrocarbon molecules, pyrolysis of polymers, treatment of carbon in the presence of nitrogen and/or phosphorus molecules, use of other templates or supports for carbon formation, such as other forms of magnesia, alumina, silica, or zeolite templates, pyrolysis of metal organic frameworks, pyrolysis of organic salts, pyrolysis of charge transfer organic complexes, and combinations thereof. Various acid or base washes can be used to remove metals, remove templates, and/or partially oxidize the carbon surface. The electro-active carbon may also undergo a second heat treatment in oxidizing, reducing, or inert atmosphere to tune surface oxidation and/or surface species.

### Example #2—Hydrophobic Functionalization of Electro-Active Carbon

Electro-active carbon, such as the one described in Example #1, can be made into a hydrophobic multi-functional additive through reaction with a precursor that selectively binds hydrophobic groups to the surface. In one preferred method, the CNₓP_{y} electro-active carbon prepared by the method used in Example #1 was treated using a reactive organosilane Chemical Vapor Deposition (CVD) method and equipment described in U.S. Pat. No. 7,413,774. While this technique is typically used for treating substrates, in a preferred method a porous rotating polymeric bag can be used to more easily facilitate powder treatment. Electro-active carbon is placed under vacuum and exposed to the reactive organo-silane vapor until saturation of the surface is achieved, as determined by vapor pressure and gas volume. In a preferred method the reactive organo-silane was R₁—Si—Cl₃, where R₁ represents the fluorocarbon chain C₈F₁₇. The C1 group on the silane can react with the carbon surface to form a functional group on the carbon, and can form a coating that is one molecule thick. The hydrophobic functional groups may be bonded to oxygen and/or bonded directly to carbon.

A thin film roll-off angle technique was used to measure hydrophobicity of the multi-functional additive. Approximately 50 mg of hydrophobic-treated electro-active carbon was mixed with 50 mg of 5-wt % sulfonated tetrafluoroethylene based fluoropolymer-copolymer (NAFION®, E. I. duPont de Nemours, Delaware, USA) dispersed in aliphatic alcohols and deposited on a carbon paper substrate. The resulting carbon coating repelled water drops at less than 2° roll-off angles, indicating super-hydrophobicity. For comparison, untreated conventional electro-active carbon (CNₓP_{y} prepared by Example 1) was similarly mixed with 5-wt % NAFION® and deposited on a carbon paper substrate. The conventional electro-active carbon film became quickly saturated with a drop of water, thus roll-off angle could not be measured, and thus the treated material clearly displayed much higher hydrophobicity.

The electro-activity of the multi-functional hydrophobic carbon additive was confirmed by cyclic voltammetry. For this testing the additive oxygen reduction activity was tested in a rotating disk electrode (RDE) set up with a glassy carbon (GC) electrode. The GC electrode was first polished with 1-μm diamond for ˜5 minutes and rinsed in DI water for 1 minute. Catalyst inks were made with a NAFION® ionomer/carbon ratio of approximately 1:1 (weight ratio) in ethanol, sonicated for 1 hour and spin dried 10 μL at 700 rpm for 1 hour. The test had a catalyst loading of approximately 40 μg/cm². Fresh 1.0 M KOH solution was made for each test. Dried inks were conditioned by cyclic voltammetry (CV) from 100 to −700 to 100 mV vs. saturated Ag/AgCl at 500 mV/s, rotated at 1250 rpm, sparged with N₂ until CVs were repeatable. Oxygen reduction was measured from 100 mV to −700 mV to 100 mV vs. Ag/AgCl at 10 mV/s, sparged with pure O₂, rotated at 1250 rpm, for 3+ cycles or until CVs overlapped. To obtain oxygen reduction current, background capacitance current correction was measured with the N₂ sparged solution and was subtracted from the current under O₂ sparging. As shown in FIG. 1, the multi-functional carbon additive had impressively high activity for oxygen reduction, with significant oxygen reduction current beginning around 0.0 V vs. Ag/AgCl. This activity matched electro-activity of materials prepared by Example 1. Surprisingly, despite the hydrophobic treatment, the electro-activity of the carbon was not adversely affected by the hydrophobic treatment or bonding hydrophobic groups to the carbon surface.

The surface area of the preferred hydrophobic and electro-active additive was measured by BET surface area analysis and had a value of 130 m²/g. Even higher surface area of electro-active carbon was obtained through treatment of a high surface area carbon, instead of MgO, with acetonitrile vapors using the process in Example 1. After hydrophobic treatment using this preferred process above, hydrophobic electro-active carbon with a surface area of >900 m²/g can be obtained.

While the above description represents a preferred method, any electro-active carbon can potentially be made hydrophobic through similar treatment. While the above description represents a preferred CVD method, other methods can be used to bind hydrophobic functional groups to the surface. While the above description represents a preferred method, numerous other functional groups can be used on the silane to tune hydrophobicity, including any C1 to C30 fluorocarbons, any C1 to C30 hydrocarbons, silane with multiple hydrophobic functional groups, functional groups that form a self-assembled superhydrophobic coating, and combinations thereof. It is also possible to use mixtures of reactive molecules to functionalize the carbon. These mixtures of reactive molecules can also include molecules with hydrophilic functional groups attached to the silane, thus creating electro-active carbon surfaces with regions of hydrophobicity and other regions with hydrophilicity. This mixture of hydrophobic and hydrophilic regions may be advantageous for some applications.

### Example #3—Supported GDE

A GDE with carbon paper support was fabricated by first dispersing hydrophobic-treated CNₓP_{y} additive (see Example 2) in a mixture of ethanol and 5% NAFION® solution. Approximately 0.2 grams of catalyst and additive was mixed with 6 mL of ethanol and 0.9 mL of 5% NAFION® in aliphatic alcohols for 1 hour using an ultrasonic bath. The solution was then hand painted on carbon paper using a camel hair brush until the desired loading was achieved. The GDE was dried at 70° C. between applications. The GDE was then dried at 70° C. overnight and the final loading recorded. The target hydrophobic carbon loading was 5 to 6 mg/cm′.

While the above represents a preferred method for preparing a GDE, numerous other approaches could be envisioned by those skilled in the art, including but not limited to spray deposition of the ink, doctor blade deposition of the ink, printing of the ink, or combinations thereof. One skilled in the art could envision use of alternative binders or ionomers, including anion-conducting ionomers, fluorinated binders, hydrocarbon binders, ionic liquids, or mixtures thereof. One skilled in the art could envision alternative substrates to carbon paper, including carbon cloth, metal felt, metal mesh, porous polymer films, catalyst coated membranes, or combinations thereof.

While the above descriptions present methods for preparing a GDE, similar methods could be used to deposit multi-functional additives as a Micro-Porous Layer (MPL) on a GDL for an electrode. In this application having a mixture of hydrophobic and hydrophilic pores may be advantageous.

### Example #4—Thick Film Electrode

Thick film GDEs with Ni mesh support were fabricated using hydrophobic electro-active carbon. Conventional CNₓP_{y} nanofibers and the multi-functional additive prepared by a method described in example #2 was uniformly dispersed in ethanol and 5% NAFION® solution and mixed for 1 hour using a sonicator. In a preferred method, 0.6 grams each of treated and untreated carbon was mixed with 18 mL of ethanol and 2.7 mL of 5% NAFION® in aliphatic alcohols. The ink was then partially dried in an oven at 70° C. until a paste-like consistency was obtained. The paste was then carefully applied on an expanded nickel mesh using a doctor-blade method. The GDE was then hot-pressed at 100° C. for 5 minutes at 1000 lbs. of force. Target catalyst loading was 10-20 mg/cm².

While the above description presents a preferred method for preparing a GDE, numerous modifications could be envisioned by those skilled in the art, including by way of example only and not limitation, alternatives to the nickel mesh support or absence of a free-standing support, alternatives to the carbon material morphology and ratios, modifications to the solvents and binders, modifications to processing conditions, use of a semi-continuous roll press, and numerous alternatives to the deposition approach.

While the above descriptions present methods for preparing a GDE, similar methods could be used to incorporate multi-functional additives into a GDL. In this application have super hydrophobic properties may be beneficial and using larger particle sizes with larger pore size may be advantageous.

### Example #5—Alkaline Fuel Cell Tests

Hydrophobic-treated CNₓP_{y} was incorporated into GDEs for alkaline oxygen reduction electrodes as a multi-functional additive and tested in half cells. Methods described in Example 3 and Example 4 respectively were used to prepare GDEs with the multi-functional additive. For comparison, a GDE with no multifunctional additive (only electro-active CNₓP_{y}) supported by carbon paper was prepared. Half-cell tests were run in an in-house constructed 2-cm² half-cell GDE set-up using nickel endplates, PTFE seals, nickel mesh current collectors, and a nickel mesh counter electrode. Pure oxygen was fed to the oxygen electrode at 50 sccm, and 5 M KOH was circulated through the counter electrode cavity at 1 mL/min. An anion-conducting membrane was used as the membrane separator. A leak-free Ag/AgCl electrode was placed inside the counter electrode chamber and results were adjusted to the reversible hydrogen electrode potential. GDEs were operated at ambient temperature and pressure. Current-voltage curves were run until the tests were repeatable. FIG. 2 compares the Oxygen Reduction Reaction (ORR) current-voltage curves respectively for a thick-film GDE with hydrophobic additive, and GDEs with and without hydrophobic CNₓP_{y}. Addition of hydrophobic CNₓP_{y} improved the current-voltage performance of the electrodes compared to no additive.

The demonstrated performance of the electrode could have numerous benefits to a wide range of applications. Such a material would function well as a hydrophobic additive, catalyst, and/or support on the air cathode side in a metal-air battery or fuel cell. The hydrophobicity of the material could reduce flooding of the cathode and/or reduce the rate of water loss from the electrolyte. Such a material could also be advantageous for electrolysis applications. For electrolysis, the material could be used as a hydrophobic additive, catalyst, and/or support in oxygen depolarized electrolysis processes (i.e. chlorine or bromine electrolysis) in the air electrode. The hydrophobicity of the material could reduce flooding of the cathode and/or improve longevity of the electrode. For electrolysis, the material could also function in gas evolution electrodes as an additive, catalyst, and/or catalyst support. In this case, the material could reduce flooding of the electrode and/or drying out of the electrolyte. If a physical porous separator with liquid electrolyte is used in an electrochemical cell, the hydrophobic properties of the additive could also improve tolerance to pressure differentials between electrode chambers.

### Example #6—Additive as a Catalyst Support

The additive can also function well as a support for catalysts. In an example of a preferred method, the additive can be used as a support for platinum-based Proton Exchange Membrane (PEM) fuel cell catalysts. The hydrophobicity of the additive could reduce the onset of flooding, allowing the cathodes to operate at higher current density. Additionally, the electro-active nature of the additive can enhance activity by adding secondary reaction sites and/or improve catalyst-support interactions. For example, binding of N or P species to the Pt can improve the durability of the catalyst by reducing Pt mobility. Additionally, electron donation from N or P to Pt can improve Pt activity. Because of the hydrophilicity on nitrogen-doped carbon, conventional electro-active carbon materials may not function well at high current density due to the propensity of water flooding. Consequently, the multi-functional additive, when used as a support for Pt, may produce a PEM catalyst that has advantageous properties for both durability and high current density which cannot be obtained with existing materials.

To prepare a catalyst for PEM fuel cell cathodes, an additive prepared by Example 2 can be mixed with a solution of chloroplatinic acid. First, the 1.0 g of chloroplatinic acid is dissolved in 100 g of deionized water. Iso-propyl alcohol may be added to reduce the surface tension of the solution. Next, 3.42 g of the solution is added dropwise to 0.052 g of the additive while mixing. The mixture can preferably be allowed to dry when the carbon pores become saturated with liquid. Once the target mass of solution is added, the catalyst can be reduced at about 70 to 350° C. in 5% hydrogen in nitrogen, or other reducing atmosphere, to form an active and hydrophobic catalyst. Preferably, the catalyst is reduced at about 200° C. in 5% hydrogen. One skilled in the art would appreciate a number of different platinum salts and/or various approaches could be used to deposit platinum on the surface of carbon and/or reduce the platinum particle.

The catalyst oxygen reduction activity was tested in a rotating disk electrode (RDE) set up with a glassy carbon electrode using common PEM fuel cell industry best practices. The GC electrode was first polished with 1 μm diamond for ˜5 minutes and rinsed in deionized (DI) water for 1 minute. Catalyst inks were made with an ionomer/carbon ratio of 2.15/1 (weight ratio) and 20% Pt (weight), sonicated in an ice bath for 1 hour and spin dried 10 μL at 700 rpm for 1 hour. The test had a catalyst loading of approximately 40 μg/cm². Fresh 0.1M HClO₄ solution (pH 1) was made for each test. Glassware was initially cleaned in 70% sulfuric acid and oxidizer solution overnight and boiled three times in DI water, then rinsed in DI water between tests. Dried inks were conditioned by cyclic voltammetry from 0.020 to 1.200 V versus Standard Hydrogen Electrode (SHE) at 500 mV/s, rotated at 1600 rpm, sparged with N₂, for 100+ cycles or until CVs were repeatable. ElectroChemically active Surface Area (ECSA) was measured by CV from 0.009 to 1.2 V SHE at 20 mV/s, sparged with N₂, no rotation, for greater than 3 cycles until CVs overlapped. ECSA was calculated via the hydrogen adsorption using the CVs measured between 0.05 and 0.4 V SHE. Oxygen reduction was measured from −0.010 to 1.020 V SHE at 20 mV/s, sparged with pure O₂, rotated at 1600 rpm, for 3+ cycles or until CVs overlapped. Background capacitance current correction was measured with the N₂ sparged solution and subtracted from the activity (current) under O₂ sparging. FIG. 3 shows the oxygen reduction activity of the catalyst using the electro-active multifunctional additive as a support for 20-wt % platinum. Surprisingly, despite the hydrophobic surface functionalization, the material showed excellent oxygen reduction activity, comparable to conventional carbon-supported catalysts. The ECSA was measured to be 59 m²/g_{Pt}. This ECSA confirms the Pt surface area is comparable to conventional catalysts.

While the description above outlines a preferred method for preparation of a catalyst using the multi-functional additive as a support, numerous variations could be envisioned by those skilled in the art. Other types of catalysts, by way of example only and not limitation, could be deposited on the support, including Pt alloys, other precious metals, precious metal alloys, cerium oxide, lanthanum oxide, transition metal ions bonded to functionalities on the carbon surface, transition metals from group 5-12 on the periodic table, metal alloys, metal oxides, metal hydroxides, metal carbides, metal borides, metal nitrides and/or metal phosphides, and combinations thereof.

While the deposition method above describes a preferred method for preparation of a catalyst using the multi-functional additive as a support, numerous variations could be envisioned by those skilled in the art including, co-precipitation, sol-gel synthesis, chemical vapor deposition, physical vapor deposition (PVD), atomic layer deposition, pyrolysis of catalyst-containing precursors, deposition followed by selective leaching, and combinations thereof.

While the reduction method above describes a preferred method for preparation of a catalyst using the multi-functional additive as a support, numerous variations could be envisioned by those skilled in the art including solution-based reduction of the catalyst using a reducing agent, thermal decomposition in inert or other atmospheres, and combinations thereof.

One skilled in the art could also envision combinations of various possible catalyst materials, deposition methods, and reduction methods.

While the above preferred method describes use of the additive as a support in PEM fuel cells, one skilled in the art would appreciate that such a catalyst would be useful in a number of other applications. For example, the electro-active hydrophobic additive could be useful as an additive, catalyst, and/or support in PEM electrolyzers on either the anode or cathode side. The CNₓP_{y}, the multi-functional additive, and/or a catalyst on the multi-functional additive support material may have activity for both the Oxygen Evolution Reaction (OER) and the Hydrogen Evolution Reaction (HER). The multi-functional material could be useful as an additive, catalyst, and/or catalyst support in PEM fuel cells on the anode side. The multi-functional material could be useful as an additive, catalyst, and/or catalyst support in PEM-based direct methanol fuel cells on either the anode or cathode side. The super hydrophobicity of the material could reduce methanol crossover. Also, electro-active CNₓP_{y} is known to not be active for methanol oxidation, an advantage for air cathodes in Direct Methanol Fuel Cells (DMFCs). The multi-functional material could be useful as an additive, catalyst, and/or catalyst support in direct alcohol fuel cells on either the anode or cathode side. The super hydrophobicity of the material could reduce alcohol crossover. Also, electro-active CNₓP_{y} is known to not be active for alcohol or hydrocarbon oxidation, an advantage for air cathodes in direct alcohol fuel cells.

### Example #7—Supercapacitor Electrode

An electrode additive, such as the additive described in Example #2 can be effectively incorporated into a supercapacitor electrode. Those skilled in the art would appreciate that the additive could be mixed in an ink and coated on a conductive substrate to form an electrode comprising hydrophobicity and high capacitance. Those skilled in the art would appreciate that the material is electro-active in the sense that free electron pairs on the carbon surface or increased electronegativity of the carbon could improve electron donation properties for charge storage and/or additional pseudocapacitance. In particular, capacitors that use a water-sensitive electrolyte and/or operate at voltages above the potential at which water splitting occurs would benefit from an electrode material that is electro-active, hydrophobic, and high surface area.

### Example #8—Lithium Ion Anode

A multi-functional electrode additive may also be useful in a lithium ion battery. In this preferred embodiment, a silicon metal particle is coated with a carbon-based coating several nanometers thick. This can be achieved, for example, through CVD of acetonitrile vapors on silicon metal particles under pyrolysis conditions similar to those outlined in Example #1. The resulting coated particle is then treated with functionalized reactive silane using the method described in Example #2. Such an electrode additive would be electro-active in the sense that the carbon coating and/or silicon core has enhanced storage of lithium ions compared to graphite. Such an electrode additive would possess significant lithium storage capacity and would be beneficial for lithium ion batteries that use water-sensitive electrolyte and/or operate at voltages above the potential where water splitting can occur. The hydrophobic functional groups could also help to stabilize the particle surface and minimize degradation of the silicon particle during lithiation/delithiation cycles. The hydrophobic films resulting from electrode casts could potentially be stored in environments where humidity is not controlled, such as outside of dry rooms, thus reducing storage or transportation costs.

While the above example represents a preferred example of how the multi-functional additive could be used in a lithium-ion battery, one skilled in the art could envision numerous modifications to the example. For instance, the silane could also possess lithium-conducting functional groups. The silane functional groups could be designed to self-assemble, thus providing order to the additive surface before and/or after expansion that occurs during lithiation. The silicon particle may be doped or alloyed with other atoms, including B, N, P, or transition metals. The silicon may be partially oxidized, or as a so-called silicon suboxide. The interface between the silicon and carbon may be a silicon carbide and/or oxide. The silicon particle may synthesized to contain internal porosity, or may be synthesized so there is porosity between the silicon and carbon coating. Such porosity within the carbon coating would reduce expansion of the coating during lithiation. Combinations of the variations discussed above could also be envisioned by one skilled in the art.

The instant invention as disclosed in multiple embodiments, all meant by way of example only and not limitation, includes, in one embodiment intended by way of example only and not limitation, an electro-active carbon-based multi-functional electrode additive that has hydrophobic functional groups chemically bonded to the surface. In various embodiments, the additive includes electro-active surface functional groups with free electron pairs. In some embodiments, these functional groups may be hydrophobic functional groups that may further include silicon bonded to the carbon surface.

In other embodiments, the additive can include a nitrogen content of 0.1-20%, while in some, the additive can include an oxygen content of 0.1-20%. The additive may have a phosphorous content of 1 ppm to 1%. In a further series of embodiments, the additive may include a silicon particle core.

In various functional applications, the additive may be a support for a catalyst, and may further include platinum. In some embodiments, the additive may be an electro-catalyst, and may include at least one region having a one hydrophilic functional group. In certain embodiments, a functional group includes C1 to C30 fluorocarbon, while a functional group may also self-assemble to form a single molecule coating. Additionally, a functional group may include C1 to C30 hydrocarbon.

In a series of other embodiments, the additive may variously have a surface area measuring greater than 100 m²/g, and/or a surface area measuring greater than 500 m²/g. From a functional viewpoint, the additive and catalyst can produce measurable current for oxygen reduction >1 mA/cm² of a coated geometric area at >0.8 V versus a reversible hydrogen electrode. In other embodiments, the additive can produce measurable current for oxygen reduction >1 mA/cm2 of a coated geometric area at >0.6 V versus a reversible hydrogen electrode.

In yet other embodiments, the additive may be applied to a variety of devices, including by way of example only and not limitation, and as would be known to one skilled in the art, such devices as a gas diffusion electrode, a battery electrode, a gas diffusion layer, an electrolysis electrode and/or a supercapacitor electrode.

One skilled in the art would know multiple methods for building and utilizing the devices and procedures outlined in the teaching above. On method could include the steps of, first, preparing carbon doped with a compound consisting of boron, nitrogen, fluorine, phosphorous, sulfur and/or chlorine; and the exposing the doped carbon to a reactive silane having at least one hydrophobic functional group. Ultimately, the carbon could be incorporated into an electrode.

Numerous alterations, modifications, and variations of the preferred embodiments disclosed herein will be apparent to those skilled in the art and they are all anticipated and contemplated to be within the spirit and scope of the disclosed specification. For example, although specific embodiments have been described in detail, those with skill in the art will understand that the preceding embodiments and variations can be modified to incorporate various types of substitute and or additional or alternative materials, relative arrangement of elements, order of steps and additional steps, and dimensional configurations. Accordingly, even though only few variations of the products and methods are described herein, it is to be understood that the practice of such additional modifications and variations and the equivalents thereof, are within the spirit and scope of the method and products as defined in the following claims. The corresponding structures, materials, acts, and equivalents of all means or step plus function elements in the claims below are intended to include any structure, material, or acts for performing the functions in combination with other claimed elements as specifically claimed.

We claim:

1. An electro-active carbon-based multi-functional electrode additive comprising hydrophobic functional groups chemically bonded to a surface.

2. The additive according to claim 1, wherein the additive comprises electro-active surface functional groups with free electron pairs.

3. The additive according to claim 1, wherein the hydrophobic functional groups comprise silicon bonded to the carbon surface.

4. The additive according to claim 1, wherein the additive comprises a nitrogen content of 0.1-20%.

5. The additive according to claim 1, wherein the additive comprises an oxygen content of 0.1-20%.

6. The additive according to claim 1, wherein the additive comprises a phosphorous content of 1 ppm to 1%.

7. The additive according to claim 1, wherein the additive comprises a silicon particle core.

8. The additive according to claim 1, wherein the additive is a support for a catalyst.

9. The additive according to claim 8, wherein the catalyst further comprises platinum.

10. The additive according to claim 1, wherein the additive is an electro-catalyst.

11. The additive according to claim 1, wherein the additive comprises at least one region having at least one hydrophilic functional group.

12. The additive according to claim 1, wherein at least one functional group comprises C1 to C30 fluorocarbon.

13. The additive according to claim 1, wherein at least one functional group comprises C1 to C30 hydrocarbon.

14. The additive according to claim 1, wherein at least one functional group self-assembles to form a coating one molecule thick.

15. The additive according to claim 1, wherein the additive has a surface area measuring greater than 100 m²/g.

16. The additive according to claim 1, wherein the additive has a surface area measuring greater than 500 m²/g.

17. The additive according to claim 8, wherein the additive and catalyst can produce measurable current for oxygen reduction >1 mA/cm² of a coated geometric area at >0.8 V versus a reversible hydrogen electrode.

18. The additive according to claim 10, wherein the additive can produce measurable current for oxygen reduction >1 mA/cm2 of a coated geometric area at >0.6 V versus a reversible hydrogen electrode.

19. The additive according to claim 1, wherein the additive is applied to a device selected from the group of devices consisting of at least one gas diffusion electrode, at least one battery electrode, at least one gas diffusion layer, at least one electrolysis electrode and at least one supercapacitor electrode.

20. A method for preparing an electro-active carbon-based multi-functional electrode additive comprising the steps of:
a. Preparing carbon doped with a compound consisting of boron, nitrogen, fluorine, phosphorous, sulfur and/or chlorine,
b. Exposing the doped carbon to a reactive silane molecule further comprising at least one hydrophobic functional group, and
c. incorporating the carbon into an electrode.
